(19) United States
(12) Patent Application Publication
(10) Pub. No.: US 2012/0199045 A1
(43) Pub. Date: Aug. 9, 2012

(54) METHOD FOR MANUFACTURING A MATERIAL FOR CENTERING A RING WITHIN A GROOVE OF A PISTON WHEN THE RING IS IN A FREE STATE

(75) Inventor: Terry A. Tomas, Clarkston, MI (US)

(73) Assignee: GM GLOBAL TECHNOLOGY OPERATIONS LLC, Detroit, MI (US)

(21) Appl. No.: 13/020,418

(22) Filed: Feb. 3, 2011

(51) Int. Cl. C08L 91/06

(52) U.S. Cl. 106/270

(57) ABSTRACT

A material for use as a centering device for centering a ring within a groove of a piston when the ring is in an uncompressed free state is manufactured from a mixture of approximately eighty (80) parts by mass petrolatum with approximately twenty (20) parts by mass carnauba wax based on one hundred (100) parts by mass of the mixture. The petrolatum and the carnauba wax are heated to a liquid state and then combined to form the mixture. Once combined, the mixture is maintained in a liquid state for a pre-defined period of time, after which the mixture is cooled to room temperature to form a block of the mixture. Once cooled, layers of the mixture are scraped from the block. Each layer includes a maximum layer thickness equal to or less than 2.5 mm.

### TECHNICAL FIELD

The invention generally relates to a method of manufacturing a material, and more specifically to a method of manufacturing a material for a centering device for centering a ring within a groove of a piston when in a free state, i.e., unassembled.

### BACKGROUND

Reciprocating internal combustion engines include an engine block that defines a plurality of bores. A piston assembly is moveably disposed within and supported by each of the bores. The piston assembly includes a body having an outer surface that defines at least one groove. A split ring defining a ring gap is disposed within each of the grooves. The ring is radially expandable out of the groove and into abutting engagement with the bore.

Prior to installation into the bore, the ring is disposed in an uncompressed condition, and includes an uncompressed diameter that is larger than a diameter of the bore. In order to install the piston assembly into the bore, the ring is compressed into a compressed condition to define a diameter less than the diameter of the bore. Once installed, the ring expands radially into contact with the bore. Just prior to ring compression, an inner face of the ring at a corner facing the gap may become radially disposed outside an outer edge of the groove, which is defined as ring “pop out”

In an effort to center the rings within the grooves of the piston, U.S. patent application Ser. No. 12/788,366, filed on May 27, 2010 by the inventor of this invention, discloses using a centering device to radially center the ring within the groove when the ring is in the uncompressed condition, prior to installation of the piston assembly into the bore of the engine block, thereby preventing ring “pop out” prior to installation of the piston assembly into the bore. The material used for the centering device should be easily compressible yet stiff enough to withstand contact with the ring and maintain ring position during shipping conditions, include a sufficient tackiness to adhere to a flank of the groove until the ring is compressed into the compressed condition during engine assembly, include a melting point greater than one hundred fifty degrees Fahrenheit (150° F.), and be soluble in engine oil.

### SUMMARY

A method of manufacturing a material for centering a ring within a groove of a piston when the ring is in a free state is provided. The method includes heating a petrolatum material to form a liquid state, and heating a carnauba wax material to form a liquid state. The liquid petrolatum material and the liquid carnauba wax material are then combined to define a mixture. The liquid petrolatum material and the liquid carnauba wax material are combined in a ratio having a range of between seventy (70) and ninety (90) parts by mass of the liquid petrolatum material based on one hundred (100) parts by mass of the mixture to between ten (10) and thirty (30) parts by mass of the carnauba wax material based on one hundred (100) parts by mass of the mixture. The method further includes cooling the mixture to a temperature equal to or greater than one hundred fifty degrees Fahrenheit (150° F.) to form a solid state of the mixture in a block.

A method of manufacturing a centering device for centering a ring within a groove of a piston when the ring is in a free state is also provided. The method includes heating a petrolatum material having specific gravity equal to or greater than 0.80 to form a liquid state, and heating a carnauba wax material having a specific gravity equal to or greater than 0.80 to form a liquid state. The liquid petrolatum material and the liquid carnauba wax material are combined to define a mixture. The liquid petrolatum material and the liquid carnauba wax material are combined in a ratio having a range of between seventy (70) and ninety (90) parts by mass of the liquid petrolatum material based on one hundred (100) parts by mass of the mixture to between ten (10) and thirty (30) parts by mass of the carnauba wax material based on one hundred (100) parts by mass of the mixture. The method further includes heating the mixture to a temperature of at least two hundred degrees Fahrenheit (200°) to maintain the mixture in a liquid state for a pre-defined period of time, and then cooling the mixture to a temperature equal to or greater than one hundred fifty degrees Fahrenheit (150° F.) to form a solid state of the mixture in a block. The block of the mixture is then cooled to a temperature equal to or less than eighty degrees Fahrenheit (80° F.). Layers of the mixture are removed from the block of the mixture after the block of the mixture has cooled to a temperature equal to or less than eighty degrees Fahrenheit (80° F.). The pre-defined maximum thickness of the layers of the mixture is less than or equal to two and one half millimeters (2.5 mm).

Accordingly, the material manufactured in the process described above is easily compressible yet stiff enough to withstand contact with the ring and maintain ring position during shipping conditions, and includes a sufficient tackiness to adhere to a flank of the groove until the ring is compressed into a compressed condition during engine assembly. Furthermore, the material includes a melting point greater than one hundred fifty degrees Fahrenheit (150° F.), and is soluble in engine oil. Accordingly, the material described above is ideally suited for use as a centering device for centering the ring within the groove when in the free state, i.e., in an uncompressed condition prior to installation into a bore of an engine block.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic cross sectional view of a piston assembly showing a ring in an uncompressed condition and centered within a groove by a centering device.

FIG. 2 is a schematic flow chart of a method of manufacturing a material for use as a centering device to center a ring within a groove of a piston when the ring is in a free state, i.e., and uncompressed condition prior to insertion into a bore of an engine block.

### DETAILED DESCRIPTION

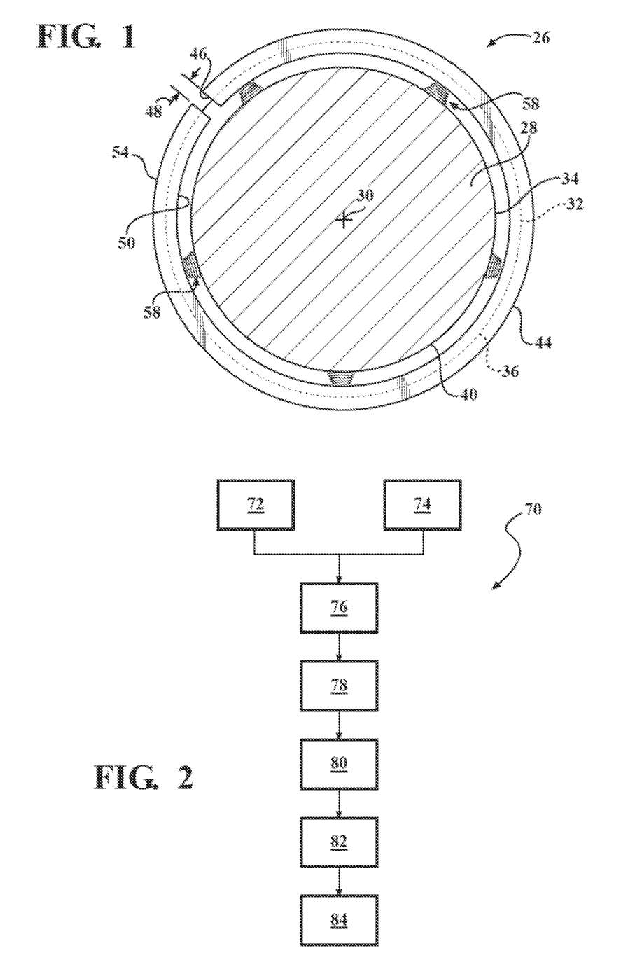

Referring to FIG. 1, a piston assembly is shown generally at 26. The piston assembly 26 includes an annular body 28 having a center disposed along a longitudinal axis 30. The annular body 28 includes an outer side surface 32 defining at least one groove 34, which is disposed circumferentially about the annular body 28, and concentric with the longitudinal axis 30. The groove 34 includes an outer groove edge 36 defining an outer groove diameter, and a root 40 defining an inner groove diameter. Typically, the annular body 28 includes three grooves 34 axially spaced from each other along the longitudinal axis 30. However, it should be appreciated that the number of grooves 34 may differ from that shown and described herein.

The piston assembly 26 further includes at least one ring 44, with one ring 44 disposed within each of the grooves 34. Accordingly, it should be appreciated that piston assembly 26 includes a corresponding number of rings 44 and grooves 34. The ring 44 includes a cut 46 defining a gap 48 extending radially across the ring 44. Accordingly, the ring 44 includes a non-continuous substantially circular shape perpendicular to the longitudinal axis 30. The cut 46 in the ring 44 permits the radial compression of the ring 44 from an uncompressed condition, shown in FIG. 1, into a compressed condition (not shown). The ring 44 includes an inner face 50 defining an inner ring diameter, and an outer face 54 defining an outer ring diameter. The ring 44 is normally biased to the uncompressed condition.

The depth of the groove 34, i.e., the radial distance between the outer groove edge 36 and the root 40, is greater than a width of the ring 44, i.e., the radial distance between the inner face 50 of the ring 44 and the outer face 54 of the ring 44. Additionally, the outer ring diameter of the ring 44 when in the uncompressed condition is greater than the outer groove diameter.

The piston assembly 26 further includes a centering device 58. The centering device 58 is disposed within the groove 34, between the inner face 50 of the ring 44 and the root 40 of the groove 34. The centering device 58 defines an inner device diameter that is greater than the inner groove diameter. Additionally, the centering device 58 defines an outer device diameter that is less than the inner ring diameter when the ring 44 is in the uncompressed condition. The centering device 58 is configured for radially spacing the ring 44 from the root of the groove 34 to prevent the inner face 50 of the ring 44 from moving radially outward beyond the outer edge of the groove 34 when the ring 44 is in the uncompressed condition. Accordingly, the centering device 58 substantially centers the ring 44 concentrically with the longitudinal axis 30 of the annular body 28 and relative to the groove 34. By centering the ring 44, when the ring 44 is in the uncompressed condition, within the groove 34, the centering device 58 prevents a corner of the inner face 50 of the ring 44 at the gap 48 from catching on the outer groove edge 36, and thereby prevents ring “pop out”, which may lead to problems assembling the piston assembly 26 into the bore.

The centering device 58 should be easily compressible yet stiff enough to withstand contact with the ring 44 and maintain ring position during shipping conditions, include a sufficient tackiness to adhere to a flank of the groove until the ring is compressed into the compressed condition during engine assembly, include a melting point greater than one hundred fifty degrees Fahrenheit (150° F.), and be soluble in engine lubricant, i.e., motor oil.

A method of manufacturing a material suitable for use as the centering device 58 is described below and shown in FIG. 2. The method, generally shown at 70, includes heating a petrolatum material, generally indicated by box 72, to form a liquid state, i.e., the petrolatum material is heated until the petrolatum material melts and forms a liquid. The petrolatum material as used herein includes a broad group of semi-solid mixtures of hydrocarbons that are obtained from petroleum, and may include but is not limited to a wax byproduct of a heavy lube oil. The petrolatum material includes a specific gravity equal to or greater than 0.80. More preferably, the petrolatum material includes a specific gravity equal to 0.86. The petrolatum material is heated to a temperature sufficient to melt the petrolatum material. For example, the petrolatum material may be heated to a temperature of at least two hundred degrees Fahrenheit (200° F.) in order to melt the petrolatum material and turn the petrolatum material into the liquid state. However, it should be appreciated that the petrolatum material may be heated to a temperature that is sufficient to melt the petrolatum material that is less than two hundred degrees Fahrenheit (200° F.).

The method further includes heating a carnauba wax material, generally indicated by box 74, to form a liquid state, i.e., the carnauba wax material is heated until the carnauba wax material melts and forms a liquid. The carnauba wax material as used herein includes a wax obtained from the leaves of the palm tree Copernicia Prunifera, i.e., the carnauba palm. The carnauba wax material is sometimes referred to as Brazil wax and/or palm wax. The carnauba wax material includes a specific gravity equal to or greater than 0.80. More specifically, the carnauba wax material includes a specific gravity equal to 0.83. The carnauba wax material is heated to a temperature sufficient to melt the carnauba wax material. For example, the carnauba wax material may be heated to a temperature of at least two hundred degrees Fahrenheit (200° F.) in order to melt the carnauba wax material and turn the carnauba wax material into the liquid state. However, it should be appreciated that the carnauba wax material may be heated to a temperature that is sufficient to melt the carnauba wax material that is less than two hundred degrees Fahrenheit (200° F.).

Once the petrolatum material and the carnauba wax material are heated to their respective liquid states, the liquid petrolatum material and the liquid carnauba wax material are combined, generally indicated by box 76, to define a mixture. The liquid petrolatum material and the liquid carnauba wax material are combined in a ratio having a range of between seventy (70) and ninety (90) parts by mass of the liquid petrolatum material based on one hundred (100) parts by mass of the mixture, to between ten (10) and thirty (30) parts by mass of the carnauba wax material based on one hundred (100) parts by mass of the mixture. Preferably, the liquid petrolatum material and the liquid carnauba wax material are combined in a ratio equal to eighty (80) parts by mass of the liquid petrolatum material based on one hundred (100) parts by mass of the mixture, to twenty (20) parts by mass of the carnauba wax material based on one hundred (100) parts by mass of the mixture.

The petrolatum material and the carnauba wax material may be combined in any suitable manner, including but not limited to pouring each into a container and stirring or otherwise mixing the combination into a uniform mixture of the petrolatum material and the carnauba wax material.

After the petrolatum material and the carnauba wax material are combined to form the mixture, the method then further includes heating the mixture to maintain the mixture in a liquid state for a pre-defined period of time, generally indicated by box 78, prior to cooling the mixture. The mixture may be heated to a temperature of at least two hundred degrees Fahrenheit (200° F.) for a period of time equal to or greater than twenty minutes (20 min), and more preferably for a period of time equal to or greater than thirty minutes (30 min). However, it should be appreciated that the temperature that the liquid mixture is maintained at in the liquid state, as well as the pre-defined period of time that the liquid mixture is maintained at, may vary from the specific temperature and time periods disclosed herein.

Once the mixture has been heated and maintained in the liquid state for the pre-defined period of time, the method further includes cooling the mixture, generally indicated by box 80. The mixture is initially cooled to a temperature equal to or greater than one hundred fifty degrees Fahrenheit (150° F.) to form a solid state of the mixture in a block. The mixture is cooled to a temperature below the melting point of the mixture, but that is greater than one hundred fifty degrees Fahrenheit (150° F.). As such, it should be appreciated that the melting point of the mixture is greater than one hundred fifty degrees Fahrenheit (150° F.). As the mixture cools to a temperature below the melting point, the mixture solidifies, and turns from the liquid state to the solid state, thereby forming a block. As used herein, the term block may include any shape and/or configuration of the mixture in the solid state.

Once the mixture has initially cooled to below the melting point of the mixture and formed the block, the mixture is further cooled to room temperature. For example, the solidified mixture may be cooled to a room temperature that is equal to or less than eighty degrees Fahrenheit (80° F.).

Once the block of the solidified mixture has cooled to room temperature, the method further includes removing layers of the mixture, generally indicated by box 82. The layers of the solidified mixture are removed from the block of the mixture in layers having a thickness that is less than a pre-defined maximum thickness. The pre-defined maximum thickness of the layers of the mixture may include a thickness that is less than or equal to two and one half millimeters (2.5 mm). More preferably, the pre-defined maximum thickness of the layers of the mixture is less than or equal to one millimeters (1.0 mm). The layers may be removed in any suitable manner, including but not limited to scraping the layers off of the block.

After the layers of the mixture are removed from the block, the method may include forming the removed layers of the mixture into a production shape, generally indicated by box 84. The production shape may include any shape suitable for use in production, including but not limited to small diameter elongated strands of the mixture. Once formed into the production shape, the mixture may then be stored in an air tight container until needed for production.

The mixture when produced in the above describe manner exhibits the required characteristic necessary for use as the centering device 58 for centering the ring 44 with in the groove 34 of the piston prior to installation of the piston into the engine block. More specifically, the mixture is easily compressible yet stiff enough to withstand contact with the ring 44 and maintain proper position of the ring 44 during shipping conditions. The mixture includes a sufficient tackiness to adhere to the flank of the groove 34 until the ring 44 is compressed into the compressed condition during engine assembly. The mixture includes a melting point that is greater than one hundred fifty degrees Fahrenheit (150° F.) to prevent melting during transportation prior to engine assembly, and is soluble in engine oil so that the mixture will melt and dissolve in the engine oil once the engine is assembled and started.

While the best modes for carrying out the invention have been described in detail, those familiar with the art to which this invention relates will recognize various alternative designs and embodiments for practicing the invention within the scope of the appended claims.

1. A method of manufacturing a material for centering a ring within a groove of a piston when the ring is in a free state, the method comprising:
heating a petrolatum material to form a liquid state;
heating a carnauba wax material to form a liquid state;
combining the liquid petrolatum material and the liquid carnauba wax material to define a mixture, wherein the liquid petrolatum material and the liquid carnauba wax material are combined in a ratio having a range of between seventy (70) and ninety (90) parts by mass of the liquid petrolatum material based on one hundred (100) parts by mass of the mixture to between ten (10) and thirty (30) parts by mass of the carnauba wax material based on one hundred (100) parts by mass of the mixture; and
cooling the mixture to a temperature equal to or greater than one hundred fifty degrees Fahrenheit (150° F.) to form a solid state of the mixture in a block.

2. A method as set forth in claim 1 further comprising heating the mixture to maintain the mixture in a liquid state for a pre-defined period of time prior to cooling the mixture.

3. A method as set forth in claim 2 wherein heating the mixture to maintain the mixture in the liquid state for the pre-defined period of time is further defined as heating the mixture to a temperature of at least two hundred degrees Fahrenheit (200° F.) to maintain the mixture in the liquid state for the pre-defined period of time.

4. A method as set forth in claim 4 wherein heating the mixture to maintain the mixture in the liquid state for the pre-defined period of time is further defined as heating the mixture to maintain the mixture in the liquid state for a period of time equal to or greater than twenty minutes (20 min).

5. A method as set forth in claim 4 wherein heating the mixture to maintain the mixture in the liquid state for the pre-defined period of time is further defined as heating the mixture to maintain the mixture in the liquid state for a period of time equal to or greater than thirty minutes (30 min).

6. A method as set forth in claim 1 wherein heating the petrolatum material to form the liquid state is further defined as heating the petrolatum material to a temperature of at least two hundred degrees Fahrenheit (200° F.).

7. A method as set forth in claim 1 wherein heating the carnauba wax material to form a liquid state is further defined as heating the carnauba wax material to a temperature of at least two hundred degrees Fahrenheit (200° F.).

8. A method as set forth in claim 1 further comprising cooling the block of the mixture to a temperature equal to or less than eighty degrees Fahrenheit (80° F.).

9. A method as set forth in claim 8 further comprising removing layers of the mixture from the block of the mixture after the block of the mixture has cooled to a temperature equal to or less than eighty degrees Fahrenheit (80° F.).

10. A method as set forth in claim 9 wherein removing layers of the mixture from the block of the mixture is further defined as removing layers of the mixture from the block of the mixture in layers having a thickness less than a pre-defined maximum thickness.

11. A method as set forth in claim 10 wherein the pre-defined maximum thickness of the layers of the mixture is less than or equal to two and one half millimeters (2.5 mm).

12. A method as set forth in claim 11 wherein the pre-defined maximum thickness of the layers of the mixture is less than or equal to one millimeters (1.0 mm).

13. A method as set forth in claim 10 further comprising forming the removed layers of the mixture into a production shape.

14. A method as set forth in claim 1 wherein the petrolatum material includes a specific gravity equal to or greater than 0.80.

15. A method of manufacturing a material for centering a ring within a groove of a piston when the ring is in a free state, the method comprising:
heating a petrolatum material having a specific gravity equal to or greater than 0.80 to a temperature of at least two hundred degrees Fahrenheit (200° F.) to form a liquid state;
heating a carnauba wax material having a specific gravity equal to or greater than 0.80 to a temperature of at least two hundred degrees Fahrenheit (200° F.) to form a liquid state;
combining the liquid petrolatum material and the liquid carnauba wax material to define a mixture, wherein the liquid petrolatum material and the liquid carnauba wax material are combined in a ratio having a range of between seventy (70) and ninety (90) parts by mass of the liquid petrolatum material based on one hundred (100) parts by mass of the mixture to between ten (10) and thirty (30) parts by mass of the carnauba wax material based on one hundred (100) parts by mass of the mixture; and
cooling the mixture to a temperature equal to or greater than one hundred fifty degrees Fahrenheit (150° F.) to form a solid state of the mixture in a block;
cooling the block of the mixture to a temperature equal to or less than eighty degrees Fahrenheit (80° F.); and
removing layers of the mixture from the block of the mixture after the block of the mixture has cooled to a temperature equal to or less than eighty degrees Fahrenheit (80° F.), wherein the pre-defined maximum thickness of the layers of the mixture is less than or equal to two and one half millimeters (2.5 mm).

16. A method of manufacturing a centering device for centering a ring within a groove of a piston when the ring is in a free state, the method comprising:
heating a petrolatum material having a specific gravity equal to or greater than 0.80 to form a liquid state;
heating a carnauba wax material having a specific gravity equal to or greater than 0.80 to form a liquid state;
combining the liquid petrolatum material and the liquid carnauba wax material to define a mixture, wherein the liquid petrolatum material and the liquid carnauba wax material are combined in a ratio having a range of between seventy (70) and ninety (90) parts by mass of the liquid petrolatum material based on one hundred (100) parts by mass of the mixture to between ten (10) and thirty (30) parts by mass of the carnauba wax material based on one hundred (100) parts by mass of the mixture;
heating the mixture to maintain the mixture in the liquid state for a period of time equal to or greater than twenty minutes (20 min);
cooling the mixture to a temperature equal to or greater than one hundred fifty degrees Fahrenheit (150° F.) to form a solid state of the mixture in a block;
cooling the block of the mixture to a temperature equal to or less than eighty degrees Fahrenheit (80° F.); and
removing layers of the mixture from the block of the mixture after the block of the mixture has cooled to a temperature equal to or less than eighty degrees Fahrenheit (80° F.), wherein the pre-defined maximum thickness of the layers of the mixture is less than or equal to two and one half millimeters (2.5 mm).

17. A method as set forth in claim 16 wherein the pre-defined maximum thickness of the layers of the mixture is less than or equal to one millimeters (1.0 mm).

18. A method as set forth in claim 16 wherein heating the mixture to maintain the mixture in the liquid state for the pre-defined period of time is further defined as heating the mixture to maintain the mixture in the liquid state for a period of time equal to or greater than twenty minutes (20 min).

19. A method as set forth in claim 16 wherein heating the petrolatum material to form the liquid state is further defined as heating the petrolatum material to a temperature of at least two hundred degrees Fahrenheit (200° F.).

20. A method as set forth in claim 16 wherein heating the carnauba wax material to form a liquid state is further defined as heating the carnauba wax material to a temperature of at least two hundred degrees Fahrenheit (200° F.).
